(19) United States
(12) Patent Application Publication
(10) Pub. No.: US 2004/0150249 A1
(43) Pub. Date: Aug. 5, 2004

(54) Side impact beam

(75) Inventors: Ludger Gehringhoff, Paderborn (DE); Johannes Schafers, Borchen (DE)

Correspondence Address: HENRY M FEIEREISEN, LLC, 350 FIFTH AVENUE, SUITE 4714, NEW YORK, NY, 10118, US

(73) Assignee: BENTELER AUTOMOBILTECHNIK GMBH, Paderborn (DE)

(21) Appl. No.: 10/722,072

(22) Filed: Nov. 24, 2003

(30) Foreign Application Priority Data
Nov. 29, 2002 (DE) 102 56 137.0

(51) Int. Cl. B60J 5/00

(52) U.S. Cl. 296/146.6

(57) ABSTRACT

A side impact beam for incorporation in a motor vehicle, in particular in a vehicle door, includes a profiled section of sheet metal having at least two longitudinal beads in side-by-side disposition. Each bead has an apex and two flanks depending from the apex, thereby defining an inner flank and an outer flank, wherein the inner flanks of the beads confront one another. The inner flanks are interconnected by a center web and are disposed in V-shaped relationship at an angle from 25° to 60°.

### CROSS-REFERENCES TO RELATED APPLICATIONS

This application claims the priority of German Patent Application, Serial No. 102 56 137.0, filed Nov. 29, 2002, pursuant to 35 U.S.C. 119(a)-(d), the disclosure of which is incorporated herein by reference.

### BACKGROUND OF THE INVENTION

The present invention relates, in general, to a side impact beam for incorporation in a motor vehicle, in particular in a vehicle door.

Side impact beams of a motor vehicle protect passengers inside a motor vehicle from crash-related injuries when the motor vehicle is hit from the side. The side impact beam is therefore used as reinforcements for vehicle doors.

German utility model DE 296 22 985 U1 discloses a side impact beam having a dual hat-shaped profile section with two longitudinal beads whose flanks extend in parallel relationship. The side impact beam is hereby made of high-strength steel from a metal strip in which the longitudinal beads are impressed in the course of a cold-forming process. In the event of a crash, this conventional side impact beam lacks sufficient deformability. In particular the transition zone between both beads (center bead) has a tendency to rupture. In addition, uncontrollable buckling may be encountered

International publication WO 99/20490 discloses a beam for a vehicle having beads with a hyperbolic cross section.

As described above, side impact beams are provided to stiffen the door structure and to absorb energy in the event of a crash from the side. Heretofore, it was generally assumed that the side impact beam should be stiff enough in a direction transversely to the travel direction in dependence on the base construction of the vehicle. Conventional designs, predominantly trapezoidal profiles, when exposed to stress, undergo in local areas considerable plastic elongation which substantially exceeds the permissible range for the material involved so that ruptures are experienced that may ultimately lead to a total failure of the structure. This plastic elongation can range up to 40% whereas high-strength steel has a permissible elongation of maximum 10%. Thus, there is a great need for improvement of the deformation behavior.

It would therefore be desirable and advantageous to provide an improved side impact beam which obviates prior art shortcomings and which is constructed to exhibit uniform deformability in the event of a side impact and to withstand highest stress.

### SUMMARY OF THE INVENTION

According to one aspect of the present invention, a side impact beam for incorporation in a motor vehicle, in particular in a vehicle door, includes a profiled section of sheet metal having at least two longitudinal beads in side-by-side disposition, each bead having an apex and two flanks depending from the apex, thereby defining an inner flank and an outer flank, wherein the inner flanks of the beads confront one another and are interconnected by a center web, and wherein the inner flanks are disposed in V-shaped relationship at an angle which is equal to or greater than 25°.

The present invention resolves prior art problems by positioning the interconnected neighboring flanks of the longitudinal beads at a V-shaped relationship, whereby the flare angle is at least 25°. As a result, the deformability is improved and more even because the flanks defining the V are able to widen so that the beads may ultimately bend over or fold. The controlled deformation of the side impact beam, especially of the V-shaped relationship of the flanks of the beads (center bead), keeps locally encountered elongations significantly below the permitted range. Thus, damage to the side impact beams as a result of cracks can thus be precluded.

According to another feature of the present invention, the angle can be equal to or smaller than 60°. In other words, the angle between the flaring neighboring flanks may range from 25° to 60° to realize a side impact beam with superior energy absorption properties.

The profiled section can be made of thin-walled metal sheets, in particular sheet steel, at a wall thickness between 1.0 mm to 3.0 mm. Shaping of the metal sheets can be realized through a cold forming process as well as a hot forming process.

According to another feature of the present invention, the neighboring flanks of the beads may have a length which is shorter than a length of the outer flanks of the beads. In other words, the so-called center bead is reduced in its vertical dimension. Tests have shown that a reduction in height of 25% to 50% is desired. As a consequence, plastic elongation can be significantly decreased and a failure of the side impact beam due to cracks is no longer an issue. In addition, deformability and stiffness of the side impact beam can be best suited to the application at hand.

According to another feature of the present invention, the inner and outer flanks of the beads may have a straight configuration, i.e. a linear ascent, while the apex of each bead and the center web for interconnecting the inner flanks are respectively curved to form an arch.

According to another feature of the present invention, the outer flanks terminate in longitudinal edges which are each connected to a flange extending transversely from the outer flanks of the beads. Suitably, the transition areas from the flanks to the edges are rounded.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a simplified vertical section of a first embodiment of a side impact beam according to the present invention;

FIG. 2 is a simplified vertical section of a second embodiment of a side impact beam according to the present invention; and

FIG. 3 is a perspective view of a side impact beam of FIG. 1.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to the drawing, and in particular to FIG. 1, there is shown a simplified vertical section of a first embodiment of a side impact beam according to the present invention, generally designated by reference numeral 1, for use as door reinforcement in a vehicle door of a motor vehicle. The side impact beam is designed as profiled section which is made from steel sheet at a wall thickness between 1.0 mm and 3.0 mm through a cold forming process or hot forming process.

The side impact beam 1 is formed along a major portion of its length with two longitudinal beads 3, 4 in side-by-side relationship. The longitudinal bead 3 has an apex 5, which is curved to form an arch, and two straight flanks 7, 8 respectively connected on both sides to the apex 5. Likewise, the longitudinal bead 4 has an apex 6, which is curved to form an arch, and two straight flanks 9, 10 respectively connected on both sides to the apex 6. The inner flanks 8, 9 of the beads 3, 4 are connected in one piece by a center web 11 which is also curved to form an arch. The outer flanks 7, 10 terminate in longitudinal edges 12, 13 for connection to respective flanges 14, 15 which extend transversely. The transition areas between the flanks 7, 10 and the flanges 14, 15 along the longitudinal edges 12, 13 have a rounded configuration.

The flanks 8, 9 interconnected by the center web 11 are positioned relative to one another in the shape of a V to define a flare angle α which is equal to or greater than 25°. At a maximum, the angle α is 60°. As a consequence of this configuration, the flanks 8, 9 are able to widen in the event of an impact from a direction indicated by arrow P so that the longitudinal beads 3, 4 can laterally bend over in response to the degree of impact. In this manner, impact energy can be substantially converted into deformation work.

The outer flanks 7, 10 of the beads 3, 4 are disposed in substantial parallel relationship and are oriented, as viewed in the drawing plane, vertically in relation to the horizontal plane HE which extends through the flanges 14, 15.

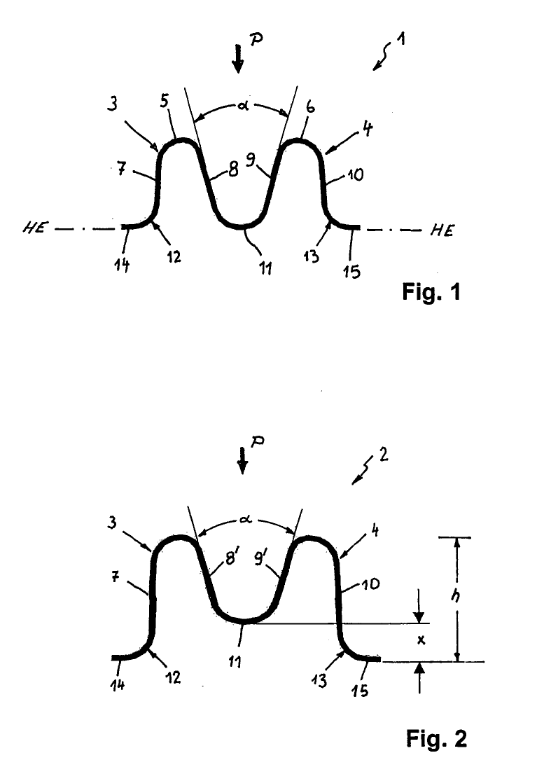

Turning now to FIG. 2, there is shown a simplified vertical section of a second embodiment of a side impact beam according to the present invention, generally designated by reference numeral 2. Parts corresponding with those in FIG. 1 are denoted by identical reference numerals and not explained again. The following description below will center on the differences between the embodiments. In this embodiment, the neighboring confronting flanks 8′, 9′ of the beads 3, 4 have a length which is shorter than the outer flanks 7, 10 of the beads 11 so that a vertical distance x is defined between the center web 11, interconnecting the flanks 8′, 9′, and the flanges 14, 15. The reduction in vertical dimension is about 25% to 50% of an overall height h of the side impact beam 2. In the non-limiting example of FIG. 2, the reduction in height amounts to about a third of the height h.

The flanks 8′, 9′ extend in V-shaped relationship to define a flare angle α between 25° and 60°. The V-shaped alignment of the flanks 8′, 9′ ensures a defined deformation behavior. In the event of a crash from the side, the flanks 8′, 9′ can widen and the longitudinal beads 3, 4 are bent away from one another to the left and to the right, respectively, as viewed in the drawing plane. Impact energy is hereby substantially absorbed by the deformation of the side impact beam 2. Critical tension and elongation are decreased and the tendency of the side impact beam for cracks or buckling is greatly diminished.

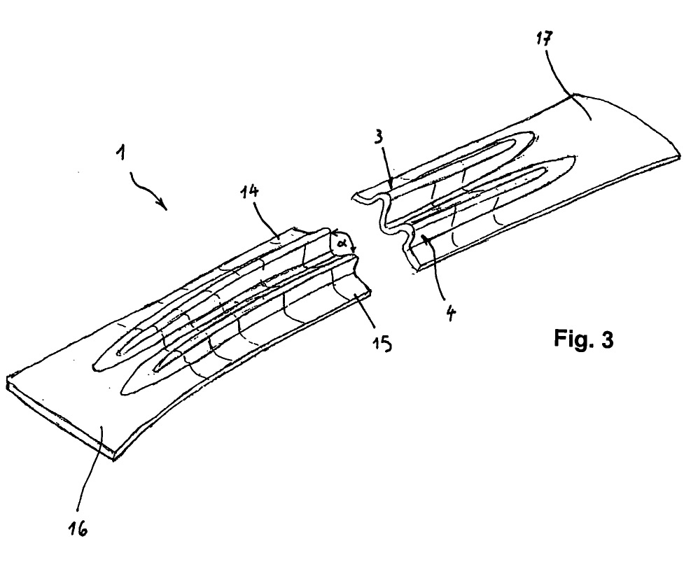

FIG. 3 is a perspective view of a side impact beam 1 of FIG. 1 and it can be seen that the side impact beam 1 is widened on both ends to form flat end zones 16, 17 for securement of the side impact beam 1 to the vehicle body, typically by welding to the door frame. The height of the longitudinal beams 3, 4 decreases continuously toward the end zones 16, 17 in an even manner to ultimately terminate in the plane of the end zones 16, 17.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A side impact beam for incorporation in a motor vehicle, in particular in a vehicle door, comprising a profiled section of sheet metal having at least two longitudinal beads in side-by-side disposition, each bead having an apex and two flanks depending from the apex, thereby defining an inner flank and an outer flank, wherein the inner flanks of the beads confront one another and are interconnected by a center web, and wherein the inner flanks are disposed in V-shaped relationship at an angle of equal to or greater than 25°.

2. The side impact beam of claim 1, wherein the angle is equal to or smaller than 60°.

3. The side impact beam of claim 1, wherein the neighboring flanks of the beads have a length which is shorter than a length of the outer flanks of the beads.

4. The side impact beam of claim 1, wherein the neighboring flanks of the beads have a length which is shorter than a length of the outer flanks of the beads by about 25% to 50%.

5. The side impact beam of claim 1, wherein the inner and outer flanks of the beads have a straight configuration, said apex of each bead and said center web being curved to form an arc.

6. The side impact beam of claim 1, wherein the outer flanks terminate in longitudinal edges, and further comprising a flange connected to the longitudinal edge of the outer flank of one of the beads and extending transversely from the outer flank of one of the beads, and a flange connected to the longitudinal edge of the outer flank of the other one of the beads and extending transversely from the outer flank of the other one of the beads.

7. The side impact beam of claim 6, wherein the flanks and the longitudinal edges define a transition area which has a rounded configuration.

8. The side impact beam of claim 1, wherein the profiled section has a wall thickness between 1.0 mm to 3.0 mm.
